(19) United States
(12) Patent Application Publication
(10) Pub. No.: US 2024/0169318 A1
(43) Pub. Date: May 23, 2024

(54) INVOKING A REPRESENTATIVE BOT BY LEVERAGING COGNITIVE ASSETS

(71) Applicant: INTERNATIONAL BUSINESS MACHINES CORPORATION, ARMONK, NY (US)

(72) Inventors: Thuan D Ngo, Milpitas, CA (US); Hrishikesh Sujaya Kumar, Bangalore (IN); Srini Bhagavan, Dublin, CA (US); Prasanna Alur Mathada, Bangalore (IN)

(21) Appl. No.: 18/057,357

(22) Filed: Nov. 21, 2022

(51) Int. Cl. G06Q 10/10; G06F 40/284; G06F 40/30

(52) U.S. Cl. CPC G06Q 10/103; G06F 40/284; G06F 40/30

(57) ABSTRACT

A method, computer system, and a computer program product for enabling virtual collaboration is provided. The present invention may include receiving a virtual collaboration history. The present invention may include generating a first module, wherein the first module is generated based on an analysis of the virtual collaboration history. The present invention may include receiving a virtual collaboration invite and generating a second module based on the virtual collaboration invite. The present invention may include monitoring a virtual collaboration. The present invention may include generating a word cloud. The present invention may include representing a user in the virtual collaboration using a proxy bot, wherein the proxy bot leverages the word cloud.

### BACKGROUND

The present invention relates generally to the field of computing, and more particularly to representative chatbots.

Nowadays, virtual collaborations and/or virtual meetings may be an integral part of an individual's day. Unfortunately, these virtual collaborations and/or virtual meetings may be overrun, or suffer from scheduling conflicts, amongst other issues. Often times, individuals who may join late and/or are unable to attend rely on agendas, summaries, and/or picking up on a discussion partway through.

Furthermore, the virtual collaborations and/or virtual meetings may miss out on valuable input from an individual unable to attend which may result in attendees moving in a direction they wouldn't have otherwise gone and/or overlooking factors the absent individual may have brought to the collaboration.

### SUMMARY

Embodiments of the present invention disclose a method, computer system, and a computer program product for enabling virtual collaboration representation. The present invention may include receiving a virtual collaboration history. The present invention may include generating a first module, wherein the first module is generated based on an analysis of the virtual collaboration history. The present invention may include receiving a virtual collaboration invite and generating a second module based on the virtual collaboration invite. The present invention may include monitoring a virtual collaboration. The present invention may include generating a word cloud. The present invention may include representing a user in the virtual collaboration using a proxy bot, wherein the proxy bot leverages the word cloud.

In another embodiment, the method may include generating a third module, wherein the third module is generated using one or more neural networks.

In addition to a method, additional embodiments are directed to a computer system and a computer program product for representing a user in a virtual collaboration using a proxy bot which may leverage a word cloud generated for one or more virtual collaboration groupings.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### BRIEF DESCRIPTION OF THE SEVERAL VIEWS OF THE DRAWINGS

These and other objects, features and advantages of the present invention will become apparent from the following detailed description of illustrative embodiments thereof, which is to be read in connection with the accompanying drawings. The various features of the drawings are not to scale as the illustrations are for clarity in facilitating one skilled in the art in understanding the invention in conjunction with the detailed description. In the drawings:

FIG. 1 depicts a block diagram of an exemplary computing environment according to at least one embodiment; and

FIG. 2 is an operational flowchart illustrating a process for enabling virtual collaboration representation according to at least one embodiment.

### DETAILED DESCRIPTION

The following described exemplary embodiments provide a system, method and program product for enabling virtual collaboration representation. As such, the present embodiment has the capacity to improve the technical field of representative chatbots by representing a user in a virtual collaboration using a proxy bot which may leverage a word cloud generated for one or more virtual collaboration groupings. More specifically, the present invention may include receiving a virtual collaboration history. The present invention may include generating a first module, wherein the first module is generated based on an analysis of the virtual collaboration history. The present invention may include receiving a virtual collaboration invite and generating a second module based on the virtual collaboration invite. The present invention may include monitoring a virtual collaboration. The present invention may include generating a word cloud. The present invention may include representing a user in the virtual collaboration using a proxy bot, wherein the proxy bot leverages the word cloud.

As described previously, nowadays, virtual collaborations and/or virtual meetings may be an integral part of an individual's day. Unfortunately, these virtual collaborations and/or virtual meetings may be overrun, or suffer from scheduling conflicts, amongst other issues. Often times, individuals who may join late and/or are unable to attend rely on agendas, summaries, and/or picking up on a discussion partway through.

Furthermore, the virtual collaborations and/or virtual meetings may miss out on valuable input from an individual unable to attend which may result in attendees moving in a direction they wouldn't have otherwise gone and/or overlooking factors the absent individual may have brought to the collaboration.

Therefore, it may be advantageous to, among other things, receive a virtual collaboration history, generate a first module, wherein the first module is generated based on an analysis of the virtual collaboration history, receive a virtual collaboration invite and generating a second module based on the virtual collaboration invite, monitor a virtual collaboration, generate a word cloud, and represent a user in the virtual collaboration using a proxy bot, wherein the proxy bot leverages the word cloud.

According to at least one embodiment, the present invention may improve virtual meeting and/or virtual collaboration summarization by effectively summarizing the conversations, conclusions, agreements, disagreements, limiting the scope of an agenda, and discussions within accessible public and/or private channels, with the ability to retain and/or discard observations.

According to at least one embodiment, the present invention may improve virtual meetings and/or virtual collaborations by mimicking human actions to collaborate and/or respond by leveraging cognitive assets.

According to at least one embodiment, the present invention may improve virtual meetings and/or virtual collaborations by providing an integrated assistance that makes decisions as to whether to retain and/or dismiss observations made in the virtual meetings and/or virtual collaborations while intelligently scrutinizing the content.

According to at least one embodiment, the present invention may improve virtual meetings and/or collaborations by leveraging proposed collaboration and/or meeting data in generating a word cloud. The word cloud being further utilized in creating a set of virtual threads using Term Frequency Document Frequency (TF-IDF) modules.

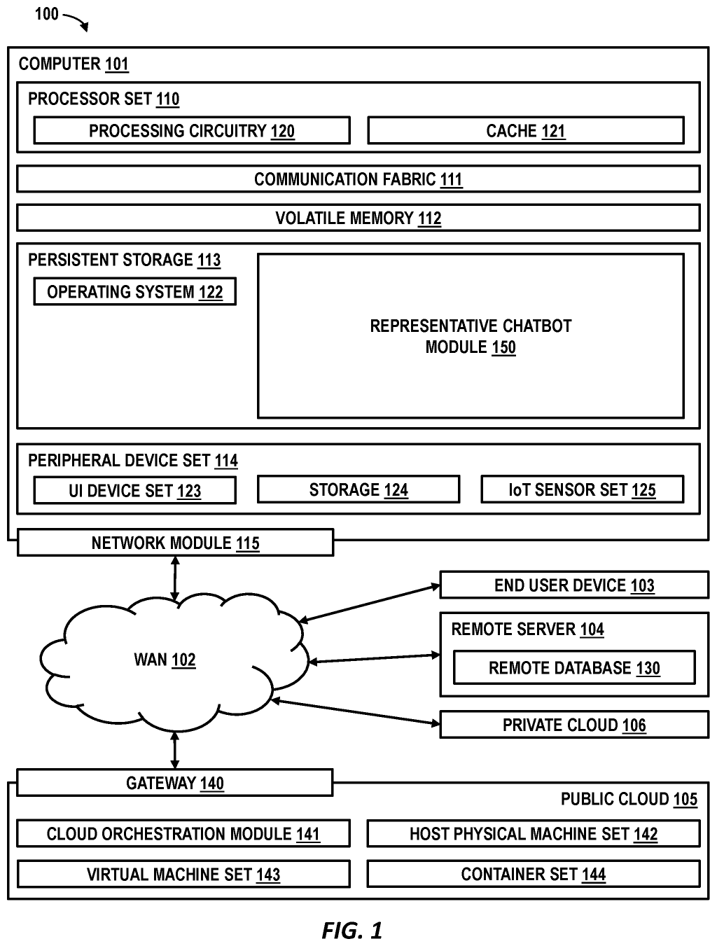

Referring to FIG. 1, Computing environment 100 contains an example of an environment for the execution of at least some of the computer code involved in performing the inventive methods, such as representing a user in a virtual collaboration using a proxy bot which may leverage a word cloud generated for one or more virtual collaboration groupings using a representative chatbot module 150. In addition to block 150, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and block 150, as identified above), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

Computer 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

Processor Set 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in block 150 in persistent storage 113.

Communication fabric 111 is the signal conduction path that allows the various components of computer 101 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

Volatile memory 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

Persistent Storage 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface-type operating systems that employ a kernel. The code included in block 150 typically includes at least some of the computer code involved in performing the inventive methods.

Peripheral device set 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

Network module 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN 102 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

End User Device (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

Remote server 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

Public cloud 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

Private cloud 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

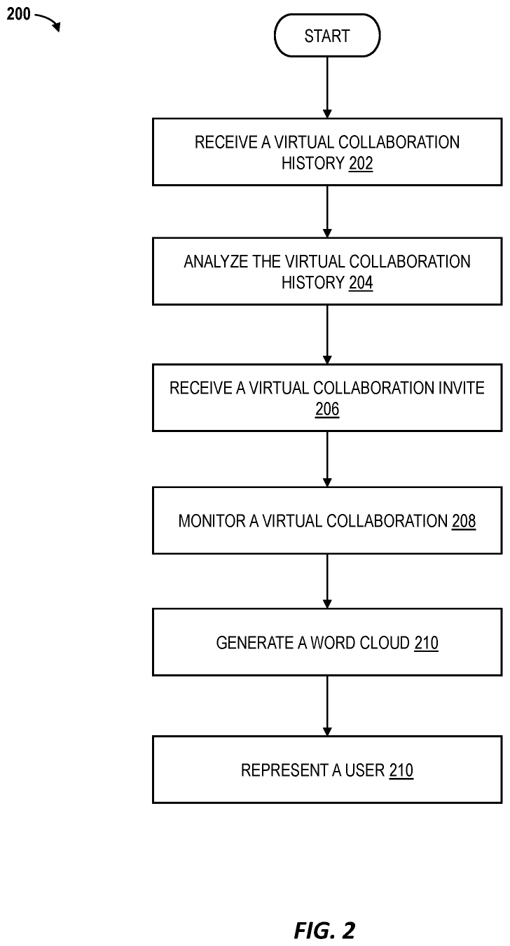

According to the present embodiment, the computer environment 100 may use the representative chatbot module 150 to represent a user in a virtual collaboration using a proxy bot which may leverage a word cloud generated for one or more virtual collaboration groupings. The enabling virtual collaboration representation method is explained in more detail below with respect to FIG. 2.

Referring now to FIG. 2, an operational flowchart illustrating the exemplary virtual collaboration representation enablement process 200 used by the representative chatbot module 150 according to at least one embodiment is depicted.

At 202, the representative chatbot module 150 receives a virtual collaboration history. The representative chatbot module 150 may receive the virtual collaboration history for an organization. The organization may be a business entity, a non-profit organization, an educational institution, or any other organization comprised of a plurality of users (e.g., employees, volunteers, students) in which meetings and/or virtual collaborations between users may be scheduled.

The representative chatbot module 150 may only receive the virtual collaboration history for one or more of the plurality of users (e.g., employees, volunteers, students) within the organization which may enable the representative chatbot module. The representative chatbot module 150 may access the virtual collaboration history specific to a user based on access granted by the user (e.g., employee, volunteer, student) within a user interface. The representative chatbot module 150 may display the user interface to the user on an EUD 103, UI device set 123 of the peripheral device set 114, and/or another device in at least an internet browser, dedicated software application, and/or as an integration with a third party software application.

The virtual collaboration history may be comprised of data with respect to a plurality of previously conducted meetings, including, but not limited to including, prior meeting minutes, meeting transcripts, invite records, attendance records, length of meetings, meeting times, meeting subjects or descriptions, whether the meeting is a recurring or one time meeting, chat discussions, amongst other virtual collaboration data. The virtual collaboration history may also include email threads, group chats, amongst other communications which the user (e.g., employee, volunteers, students) may enable. The organization may set additional limits as to what data the representative chatbot module 150 may access and/or requirements as to approval. The representative chatbot module 150 may not access data in violation of any law with respect to privacy protection. As will be explained in more detail below, the representative chatbot module may periodically require the user to renew consent. The representative chatbot module 150 may display one or more prompts within the user interface and/or send notifications to the EUD 103 of the user over periodic timeframes allowing the user to confirm and/or reject consent to access data. The representative chatbot module 150 may only extract virtual collaboration data for the plurality of users and/or the organization after receiving consent from either each of the plurality of users and/or an authorized party of the organization. For example, User 1 may meet with User 2, User 3, and User 4 in a team meeting every week. The representative chatbot module 150 may receive the virtual collaboration history for the meeting history, including, meeting transcripts, invite records, attendance records, length of meetings, meeting times, meeting subjects or descriptions, chat discussions, amongst other data. Additionally, Users 1, 2, 3, and 4 may utilize a messaging platform to communicate throughout the week. The representative chatbot module 150 may require approval from all 4 Users prior to accessing the collaboration history of the messaging platform.

The user (e.g., employee, volunteer, student) may also be able to group one or more virtual collaboration histories together within the user interface. Continuing with the above example, User 1 may be permit access to the representative chatbot module 150 for the meetings history and messaging platform history, as well as additional virtual collaboration histories. In this example, User 1 may group the meetings and messaging history with Users 2, 3, and 4, in the user interface such that the representative chatbot module may associate the two histories as related. As will be explained in more detail below, the representative chatbot module 150 may also associate two or more virtual collaborations using one or more linguistic analysis and/or matching techniques.

The representative chatbot module 150 may store each virtual collaboration grouping in a knowledge corpus (e.g., database 130). The representative chatbot module 150 may also store each word cloud created based on corresponding modules and/or models for each virtual collaboration grouping such that the representative chatbot module 150 may continuously update the word cloud for each virtual collaboration grouping as additional collaborations may be conducted.

At 204, the representative chatbot module 150 analyzes the virtual collaboration history. The representative chatbot module 150 may analyze the virtual collaboration history in building at least one of a plurality of virtual threads. As will be explained in more detail below, the virtual threads may be a set of grouped according to virtual collaboration grouping, the plurality of users involved, subject matter, amongst other criteria. The representative chatbot module 150 may analyze the virtual collaboration history using one or more linguistic analysis techniques and/or visual analysis techniques. As will be explained in more detail below with respect to at least steps 206 and/or 208 the representative chatbot module may utilize the one or more linguistic analysis techniques and/or the visual analysis techniques in generating a unique set of modules which may be comprised of at least two or more Term Frequency-Inverse Document Frequency (TF-IDF) modules and/or Skip-Gram models.

The representative chatbot module 150 may analyze the virtual collaboration history for each of the one or more of the plurality of users (e.g., employees, volunteers, students) within the organization which enabled the representative chatbot module. The representative chatbot module 150 may analyze the virtual collaboration history for each user based on the access granted by the user (e.g., employee, volunteer, student) within the user interface. The representative chatbot module 150 may utilize the one or more linguistic analysis techniques in generating a first module, the first module may be a TF-IDF module. The one or more linguistic analysis techniques may include, but are not limited to including, a machine learning model with Natural Language Processing (NLP), Latent Dirichlet Allocation (LDA), speech-to-text, Hidden markov models (HMM), N-grams, Speaker Diarization (SD), Semantic Textual Similarity (STS), Keyword Extraction, amongst other analysis techniques, such as those implemented in IBM Watson® (IBM Watson and all Watson-based trademarks are trademarks or registered trademarks of International Business Machines Corporation in the United States, and/or other countries), IBM Watson® Speech to Text, IBM Watson® Tone Analyzer, IBM Watson® Natural Language Understanding, IBM Watson® Natural Language Classifier, amongst other implementations. The TF-IDF module generated by the representative chatbot module utilizing the one or more linguistic analysis techniques may be comprised of virtual threads segregated by thread signatures. The one or more virtual threads may be the one or more virtual collaboration groupings stored in the knowledge corpus (e.g., database 130) and the thread signatures may be a set of virtual collaborations and/or collaborations grouped together based on the context of the discussion between the plurality of users. The TF-IDF module may be stored for each virtual collaboration grouping by the representative chatbot module 150 in the knowledge corpus (e.g., database 130).

The representative chatbot module 150 may analyze the virtual collaboration history for each user for each of the one or more virtual collaboration histories which may be grouped together as described in more detail above with respect to step 202. As will be explained in more detail below, the representative chatbot module may utilize the one or more virtual collaboration histories in understanding how the user interacts in specific groups such that the representative chatbot module 150 may represent the user in those groups accurately based on the virtual collaboration history. For example, User 1 may have grouped two different virtual collaboration histories together in the user interface at step 202. Based on the virtual collaboration history for each group the representative chatbot module 150 may determine the user has a lower likelihood of participating in Group 1 versus Group 2 and may utilize these collaboration histories such that the representative chatbot module 150 may only generate summaries for Group 1 collaborations in which the user is absent but actively participate on behalf of the user in Group 2 should the user be absent.

At 206, the representative chatbot module 150 receives a virtual collaboration invite. The representative chatbot module 150 may analyze the virtual collaboration invite using at least the one or more linguistic analysis techniques described above and/or visual analysis techniques in generating a second module, wherein the second module may be a TF-IDF module generated based on at least the virtual collaboration invite, metadata associated with the virtual collaboration invite, and/or a visual analysis of the collaboration corresponding to the virtual collaboration invite.

The representative chatbot module 150 may utilize the one or more linguistic analysis techniques and/or visual analysis techniques in analyzing the virtual collaboration invite and/or metadata associated with the virtual collaboration invite, which may include, but is not limited to including, a subject line, a meeting agenda, whether the meeting is a recurring or one time meeting, a recipient and/or invite list, one or more attached documents, attached images and/or other visually instructive material, scanned documents, amongst other data and/or information which may be included with the virtual collaboration invite. The representative chatbot module 150 may utilize the one or more linguistic analysis techniques described above in generating the second module, wherein the second module may the TF-IDF module generated based on the virtual collaboration invite and/or metadata associated with the virtual collaboration. The representative chatbot module 150 may additionally utilize one or more visual analysis techniques in generated the second TF-IDF module, the one or more visual analysis techniques may include, but are not limited to including, an Optical Character Reader (OCR) which may be utilized by the representative chatbot module 150 in reading through attached visual files of the virtual collaboration invite. As described at step 204, the representative chatbot module 150 may identify a grouping for the virtual collaboration invite corresponding to at least one of the one or more groupings of the virtual collaboration history. The representative chatbot module 150 may group the second TF-IDF module with the corresponding first TF-IDF module of the same group.

The virtual collaboration invite may be displayed in the user interface and/or in an internet browser, dedicated software application, and/or as an integration with a third party software application. The user may select one or more options within the user interface using the EUD 103, UI device set 123 of the peripheral device set 114, and/or another device. The one or more options may include, but are not limited to including, unable to attend, able to attend, tentative, unable to attend but request representation, unable to attend but request summary, able to attend but may be late due to a scheduling conflict, amongst other options. As will be explained in more detail below, the representative chatbot module 150 may also automatically provide representation to the user and/or generate a summary based on default settings and/or settings enabled by the user within the user interface. As will be described in more detail below with respect to step 208, the representative chatbot module 150 may monitor the meeting based on the option selected by the user in the user interface, the default setting, and/or the settings enabled by the user within the user interface.

The representative chatbot module 150 may additionally require consent from the user with respect to accessing data related to the corresponding virtual collaboration invite. The user may modify consent for particular virtual collaboration invites and/or other data in the user interface using the EUD 103.

At 208, the representative chatbot module 150 monitors a virtual collaboration. The representative chatbot module 150 may monitor the virtual collaboration corresponding to the virtual collaboration received in accordance with the option selected by the user in the user interface, the default settings, and/or the settings enabled by the user within the user interface.

The representative chatbot module 150 may monitor visual content of the virtual collaboration, such as, but not limited to, images shared, videos shared, and/or screensharing using at least the visual analysis techniques described above with respect to step 206. The representative chatbot module 150 may monitor text content of the virtual collaboration using the one or more linguistic analysis techniques described at step 204. The representative chatbot module 150 may monitor the virtual collaboration whether the user is present or absent from the virtual collaboration. As will be described in more detail below, the representative chatbot module 105 may monitor the user's participation in virtual collaborations to learn how the user participates in each virtual collaboration grouping such that the representative chatbot module 150 may represent the user in virtual collaborations of the same grouping. For example, the representative chatbot module 150 may shortlist the user based on an invite list and/or the conversations carried out with respect to the virtual collaboration and the context involved. In this example, irrespective of whether the user makes it to the virtual collaboration or not the representative chatbot module 150 may map a query with the contextual input available in the form of virtual threads and accordingly articulate a response on behalf of the user.

The representative chatbot module 150 may also monitor the virtual collaboration using one or more neural networks, such as, but not limited to a skip-gram model. The one or more neural networks may be utilized by the representative chatbot module in monitoring audio collaboration between the plurality of users in the virtual collaboration. The representative chatbot module 150 may utilize the one or more neural networks in generating a module based on at least phonology, morphology, and/or lexical style of the audio collaboration between users of the virtual collaboration. As will be described in more detail below with respect to step 210 the representative chatbot module 150 may utilize at least the two or more unique set of modules which may include the first TF-IDF module, the second TF-IDF module, and the skip-gram model in generating a word cloud for each of the virtual collaboration groupings such that the representative chatbot module 150 may represent the user according to the option selected by the user in the user interface, the default settings, and/or the settings enabled by the user within the user interface.

At 210, the representative chatbot module 150 generates a word cloud. The representative chatbot module 150 may generate the word cloud based on the at least two or more unique set of modules which may include the first TF-IDF module, the second TF-IDF module, and the skip-gram model. The representative chatbot module 150 may generate the word cloud for each of the virtual collaboration groupings. The word cloud generated for each virtual collaboration grouping may be unique. The word cloud may be stored by the representative chatbot module 150 in the knowledge corpus (e.g., database 130).

The word cloud may be comprised of word embeddings derived from the plurality of modules which may include at least the first TF-IDF module, the second TF-IDF module, and the skip-gram model. The representative chatbot module 150 may generate the word cloud by comparing at least the key words using one or more word embedding techniques to validate and/or rank the one or more key words which may be most similar and may enable construction of a context in which they may be used in a virtual collaboration. The word cloud described may refer to the ranked list of key words which may have been trimmed for subsequent processing. The representative chatbot module may utilize a machine learning model with NLP and/or one or more word vectorization techniques in mapping the key words and determining a similarity based on a shortest path distance.

The representative chatbot module 150 may utilize the skip gram model in building keywords and/or sentences around a central word which may be identified by the representative chatbot module 150 as the contextual keyword. The representative chatbot module 150 may utilize the first TF-IDF module and/or the second TF-IDF module in understanding an importance of a given word and assigning a corresponding weightage. Accordingly, the representative chatbot module 150 may derive the ranked list of keywords and generate the word cloud using the one or more TF-IDF modules and leverage the skip-gram model in parsing through the virtual collaborations to assign context to the ranked list of keywords iteratively based on the first TF-IDF module and/or the second TF-IDF module to generate a word embedding.

At 212, the representative chatbot module 150 represents a user in the virtual collaboration. The representative chatbot module 150 may represent the user in the virtual collaboration using a proxy bot. The proxy bot may utilize in IBM Watson® assistant features (IBM Watson, Ask Watson®, and all Watson-based trademarks are trademarks or registered trademarks of International Business Machines Corporation in the United States, and/or other countries), and the word cloud in representing the user in the virtual collaboration. The proxy bot may leverage IBM Watson® assistant features, such as, but not limited to, conversation features, speech to text features, text to speech features, dialogue mapping with respect to intentions, amongst other features.

The representative chatbot module 150 may use the proxy bot to represent the user in the virtual collaboration according to the option selected by the user in the user interface, the default settings, and/or the settings enabled by the user within the user interface. The one or more options may include, but are not limited to including, unable to attend, able to attend, tentative, unable to attend but request representation, unable to attend but request summary, able to attend but may be late due to a scheduling conflict, amongst other options. For example, if the user selects and/or has enabled the option “unable to attend but request representation” the proxy bot may monitor the virtual collaboration and respond to queries of other users by considering the context and determining an appropriate response from the plurality of virtual threads of the word cloud corresponding to the virtual collaboration grouping.

In an embodiment, the proxy bot may represent the user both in the absence of the user and in the presence of the user. In this embodiment, the proxy bot may be trained according to at least the virtual collaboration history received at step 202 and the virtual collaboration monitoring described at step 208. In this embodiment the proxy bot utilizes virtual collaboration history stored in the knowledge corpus (e.g., database 113) in order to present the user with possible feedback based on the context of the virtual collaboration and the priority and/or ranking of the one or more keywords in the word cloud for the particular virtual collaboration grouping. In this embodiment, the proxy bot may continuously generate feedback for the virtual collaboration on the user's behalf and may display such feedback to the user within the user interface using the EUD 103, UI device set 123 of the peripheral device set 114, and/or another device. The user may select one or more options related to the feedback which may be utilized as a feedback mechanism in training the proxy bot in further representing the user. The representative chatbot module 150 may continuously sort and/or rank the one or more keywords of the word cloud depending on the real time context of the virtual collaboration derived using at least the one or more linguistic analysis techniques and the proxy bot may utilize the word cloud to address answers and/or queries of the virtual collaboration accordingly.

In another example, the user may select and/or enable the option “able to attend but may be late due to scheduling conflict” in this example the proxy bot may monitor the virtual collaboration and participate on behalf of the user while generating a ranked summary to be presented to the user once the user joins the meeting. The ranked summary may be organized specific to the user. For example, User A over the past week has been meeting with Users B, C, and D with respect to security features. Over the same period of time User A has also been meeting with Users X, Y, and Z with respect to database features. Accordingly, when User A is unable to attend a virtual collaboration the representative chatbot module 150 understands the users involved and based on the context may weave together the conversations in order to present the ranked summary to User A once the user joins the virtual collaboration and/or following the virtual collaboration. In another example, User A may frequently collaborate with Users B, C, D, X, Y, and Z with respect to various product features. In this example the representative chatbot module 150 may be able to parse the virtual collaborations in determining topics discussed with which users and build a timeline. In the ranked summary presented to the user the representative chatbot module may present two unique ranked summaries. One with respect to the discussion of B, C, and D with respect to security features and one with respect to X, Y, and Z with respect to database features such that User A may understand the context of the virtual collaboration and the plurality of users associated with topics discussed in context.

It may be appreciated that FIG. 2 provides only an illustration of one embodiment and do not imply any limitations with regard to how different embodiments may be implemented. Many modifications to the depicted embodiment(s) may be made based on design and implementation requirements.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope of the described embodiments. The terminology used herein was chosen to best explain the principles of the embodiments, the practical application or technical improvement over technologies found in the marketplace, or to enable others of ordinary skill in the art to understand the embodiments disclosed herein.

The present disclosure shall not be construed as to violate or encourage the violation of any local, state, federal, or international law with respect to privacy protection.

What is claimed is:

1. A method for enabling virtual collaboration representation, the method comprising:
receiving a virtual collaboration history;
generating a first module, wherein the first module is generated based on an analysis of the virtual collaboration history;
receiving a virtual collaboration invite and generating a second module based on the virtual collaboration invite;
monitoring a virtual collaboration;
generating a word cloud; and
representing a user in the virtual collaboration using a proxy bot, wherein the proxy bot leverages the word cloud.

2. The method of claim 1, wherein receiving the virtual collaboration history further comprises:
creating one or more virtual collaboration groupings.

3. The method of claim 1, wherein the first module is generated using one or more linguistic analysis techniques.

4. The method of claim 1, wherein monitoring the virtual collaboration further comprises:
generating a third module, wherein the third module is generated using one or more neural networks.

5. The method of claim 4, wherein the third module is a skip-gram model.

6. The method of claim 1, wherein the word cloud is generated using at least the first module, the second module, and a third module.

7. The method of claim 1, wherein the user is represented in the virtual collaboration according to one or more options selected by the user in a user interface.

8. A computer system for enabling virtual collaboration representation, comprising:
one or more processors, one or more computer-readable memories, one or more computer-readable tangible storage medium, and program instructions stored on at least one of the one or more tangible storage medium for execution by at least one of the one or more processors via at least one of the one or more memories, wherein the computer system is capable of performing a method comprising:
receiving a virtual collaboration history;
generating a first module, wherein the first module is generated based on an analysis of the virtual collaboration history;
receiving a virtual collaboration invite and generating a second module based on the virtual collaboration invite;
monitoring a virtual collaboration;
generating a word cloud; and
representing a user in the virtual collaboration using a proxy bot, wherein the proxy bot leverages the word cloud.

9. The computer system of claim 8, wherein receiving the virtual collaboration history further comprises:
creating one or more virtual collaboration groupings.

10. The computer system of claim 8, wherein the first module is generated using one or more linguistic analysis techniques.

11. The computer system of claim 8, wherein monitoring the virtual collaboration further comprises:
generating a third module, wherein the third module is generated using one or more neural networks.

12. The computer system of claim 11, wherein the third module is a skip-gram model.

13. The computer system of claim 8, wherein the word cloud is generated using at least the first module, the second module, and a third module.

14. The computer system of claim 8, wherein the user is represented in the virtual collaboration according to one or more options selected by the user in a user interface.

15. A computer program product for enabling virtual collaboration representation, comprising:
one or more non-transitory computer-readable storage media and program instructions stored on at least one of the one or more tangible storage media, the program instructions executable by a processor to cause the processor to perform a method comprising:
receiving a virtual collaboration history;
generating a first module, wherein the first module is generated based on an analysis of the virtual collaboration history;
receiving a virtual collaboration invite and generating a second module based on the virtual collaboration invite;
monitoring a virtual collaboration;
generating a word cloud; and
representing a user in the virtual collaboration using a proxy bot, wherein the proxy bot leverages the word cloud.

16. The computer program product of claim 15, wherein receiving the virtual collaboration history further comprises:
creating one or more virtual collaboration groupings.

17. The computer program product of claim 15, wherein the first module is generated using one or more linguistic analysis techniques.

18. The computer program product of claim 15, wherein monitoring the virtual collaboration further comprises:
generating a third module, wherein the third module is generated using one or more neural networks.

19. The computer program product of claim 18, wherein the third module is a skip-gram model.

20. The computer program product of claim 15, wherein the word cloud is generated using at least the first module, the second module, and a third module.
